(19) United States
(12) Patent Application Publication
(10) Pub. No.: US 2026/0240174 A1
(43) Pub. Date: Aug. 20, 2026

(54) TRAVELING WIRE BRACKET FOR HARD TACO SHELL SHEETING MACHINE

(71) Applicant: GENERAL MILLS, INC., Minneapolis, MN (US)

(72) Inventors: Douglas Dale Beldon, Shelbina, MO (US); Adam Renaud Dillard, Hannibal, MO (US); Bryan Lee Luckey, Hannibal, MO (US); Justin William Trantham, New London, MO (US)

(73) Assignee: GENERAL MILLS, INC., Minneapolis, MN (US)

(21) Appl. No.: 19/161,392

(22) PCT Filed: Feb. 14, 2024
(86) PCT No.: PCT/US2024/015668

§ 371 Date: Sep. 2, 2025

Related U.S. Application Data
(60) Provisional application No. 63/450,403, filed on Mar. 7, 2023.

(51) Int. Cl. A21C 3/02

(52) U.S. Cl. CPC A21C 3/02

(57) ABSTRACT

A bracket (100) for a traveling wire (76) in a dough sheeting device (10) includes a stationary base including a base plate (110), a support track (120) mounted on the base plate (110), and a retainer (125) attached to the support track (120) with fasteners (126). A rod (130) is adjustably mounted in the support track (120). The rod (130) includes a mounting portion (135) secured in the track (120) by the retainer (125). The rod (130) also includes a guide portion (136) fixed to the mounting portion (135). The guide portion (136) includes a tab (140) with a notch (150) configured to retain the traveling wire (76) in proper position, while preventing excessive wear on a sheet roller (40), and intermittent jumping of the traveling wire (76).

### FIELD OF THE INVENTION

The invention generally pertains to sheeting machines for hard taco shells. More particularly the invention pertains to sheeting machine with an improved traveling wire assembly including a bracket for securing a traveling wire in place along the sheeting machine.

### BACKGROUND OF THE INVENTION

A dough sheeting machine or sheeter is a device commonly used in the food industry for making flattened food products in a continuous processing operation. Dough sheeting machines are used in the production of thin corn products formed from unleavened cornmeal dough such as tortillas and tacos. These machines typically have a pair of counter rotating sheeting rollers positioned beneath a hopper. The dough product is compressed between the sheeting rollers that are located closely together, thereby providing a pinch point through which the dough is formed into sheets. Many dough products, particularly those that are corn based (“masa”), tend to stick to the sheeter rollers rather than dropping onto a conveyer.

One common approach to this problem is to string a traveling wire across the face of one of the sheeter rollers so that the traveling wire can scrape away the dough product off of the surface of the roller. The sheet is peeled from one of the sheeting rollers by the wire so that the entire sheet is carried by the second roller. A cutting device acting against the second roller outlines product pieces in the sheet. A second traveling wire is provided to strip the masa sheet and the product pieces from the second roller after the cutting operation. The product pieces fall onto a conveyor. In some arrangements, the scrap portions of the sheet are carried along with the second roller back into the hopper assembly.

The second roller is provided with spaced circumferential grooves in which hoops are loosely positioned. The hoops are formed in place from bands having adjustably interlocking ends. The formed hoops have a diameter slightly less than that of the roller so that they remain captive within the grooves. The grooves are sufficiently deep to allow the hoops to assume eccentric positions in which they protrude from the grooves a significant distance.

As the masa sheet is formed between the sheeting rollers, the masa is pressed against the hoops as well as the cylindrical surfaces of the rollers. Therefore, the masa sheet adheres to the hoops also. The second traveling wire is threaded through the hoops so that as the wire peels the masa sheet from the surface of the roller, the sheet continues to adhere to the hoops and the cut pieces are severed from the sheet and fall onto the conveyor as the sheet is peeled from the roller, but the remainder of the sheet is carried back into the hopper. The hoops also assist in holding the second traveling wire in place against the second roller. Typically, piano wire or similar high tensile strength round wire has been used exclusively as the traveling wires. The traveling wire is often arranged to travel along the second roller so that the section of wire peeling the dough is constantly refreshed. A guide wire may also be employed to assist with guiding the traveling wire. However, the traveling wire can be moved by the second roller and thus may cause excessive wear on the sheeter rolls, and intermittent jumping of the traveling wire, leading to premature band failures and breakage of both the traveling and guide wires.

Therefore, there exists a need for a device that will retain the traveling wire in proper position, while preventing excessive wear on the sheeter rolls, and intermittent jumping of the traveling wire.

### SUMMARY OF THE INVENTION

A bracket for a traveling wire in a dough sheeting device includes a stationary base including a base plate, a support track mounted on the base plate, and a retainer attached to the support track with fasteners. A rod is adjustably mounted in the support track. The rod includes a mounting portion secured in the track by the retainer. The rod also includes a guide portion fixed to the mounting portion. The guide portion includes a tab with a notch configured to support the traveling wire. A lever is mounted on the stationary base and is connected to the rod.

In operation the bracket retains a wire in the dough sheeting device and is installed by positioning the stationary base under a sheeter roller of the dough sheeting device with a tab of the bracket being near the traveling wire. The height of the bracket is then adjusted by moving the lever mounted on the stationary base. The bracket moves from a lowered stowed configuration with the traveling wire disengaged from the notch to a raised deployed position engaging the traveling wire with the notch. The notch supports the traveling wire and retains the traveling wire in proper position, while preventing excessive wear on the sheeter rolls, and intermittent jumping of the traveling wire.

### BRIEF DESCRIPTION OF THE DRAWINGS

FIG. 1 is a perspective view of a dough sheeting machine with a hopper.

FIG. 2 is an upper perspective view of the dough sheeting machine of FIG. 1 with the hopper removed showing sheeter rollers.

FIG. 3 is a lower perspective view of the underside of dough sheeting machine of FIG. 1 showing one of the sheeter rollers and a cutting roller with a bracket supporting a traveling wire on the sheeter roller.

FIG. 4 is a lower perspective view of the dough sheeting machine of FIG. 1 showing a bracket being retracted.

FIG. 5 is a perspective view of the bracket of FIG. 3.

Additional objects, features and advantages of the invention will become more readily apparent from the following detailed description of preferred embodiments thereof when taken in conjunction with the drawings wherein like reference numerals refer to common parts in the several views.

### DETAILED DESCRIPTION OF EMBODIMENTS

The following detailed description should be read with reference to the drawings in which similar elements in different drawings are numbered the same. The detailed description and the drawings, which are not necessarily to scale, set forth illustrative and exemplary embodiments and are not intended to limit the scope of the disclosure.

Selected features of any illustrative embodiment can be incorporated into an additional embodiment unless clearly stated to the contrary. While the disclosure is amenable to various modifications and alternative forms, specifics thereof have been shown by way of example in the drawings and will be described in detail. As used herein in the specification and claims, including as used in the examples and unless otherwise expressly specified, all numbers may be read as if prefaced by the word “about” or “approximately,” even if the term does not expressly appear, with it being understood that this provides a reasonable expected range of values in the order of +/−10% of the stated value (or range of values). In addition, any numerical range recited herein is intended to include all sub-ranges subsumed therein. Overall, it should be understood, however, that the intention is not to limit aspects of the disclosure to the particular illustrative embodiments described. On the contrary, the intention is to cover all modifications, equivalents, and alternatives falling within the spirit and scope of the disclosure.

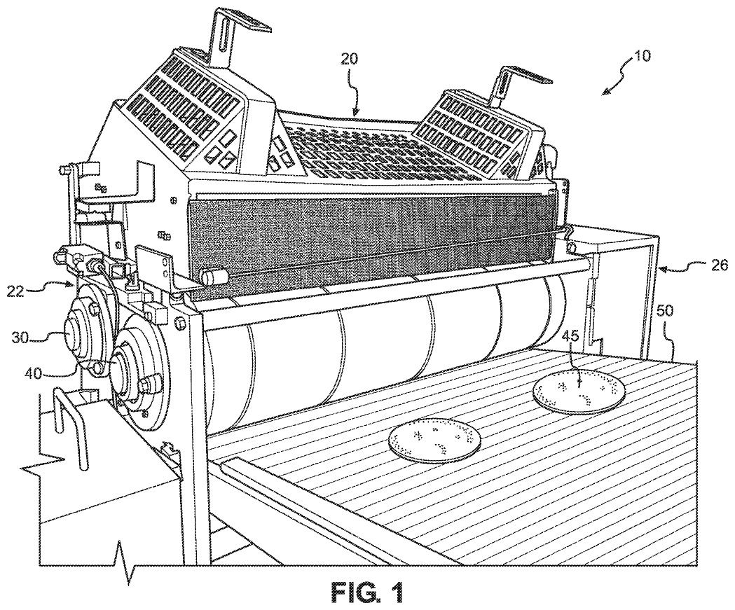

FIG. 1 illustrates a dough sheeting machine 10. The dough sheeting machine 10 is configured for taco production, and can include various types of electronic thickness control, pinch point gap control, and other related systems and functionality. The embodiments disclosed herein have applicability to a variety of different types of food rolling machines and sheeters, however, dough sheeting machine 10, configured to make tacos, provides useful context for appreciation of the embodiments disclosed herein.

With continued reference to FIG. 1, dough sheeting machine 10 includes a hopper assembly 20, roller assembly 22 and a support frame assembly 26. The support frame assembly 26 is in the form of a housing which can include and support various types of devices for operations of dough sheeting machine 10. The roller assembly 22 includes two sheeter rollers, a rear roller 30 and a front roller 40, that are both generally cylindrical. The rear roller 30 and the front roller 40 are rotated in opposite directions and can be driven at the same speed or slightly different speeds, depending on desired performance characteristics. The rear roller 30 and the front roller 40 are positioned generally parallel to each other. The roller assembly 22 can include an electric motor and an appropriate gear reduction mechanism (not separately shown) for driving a shaft of one or both of rear roller 30 and the front roller 40. Further details of an electric motor and drive system can be found in US 2021/0298314, incorporated herein by reference. The roller assembly 22 is attached to the support frame assembly 26. The hopper assembly 20 is supported above the roller assembly 22. The hopper assembly 20 supplies dough to the rear roller 30 and the front roller 40 so that the sheeting machine 10 produces round shaped dough pieces 45 on a conveyor 50.

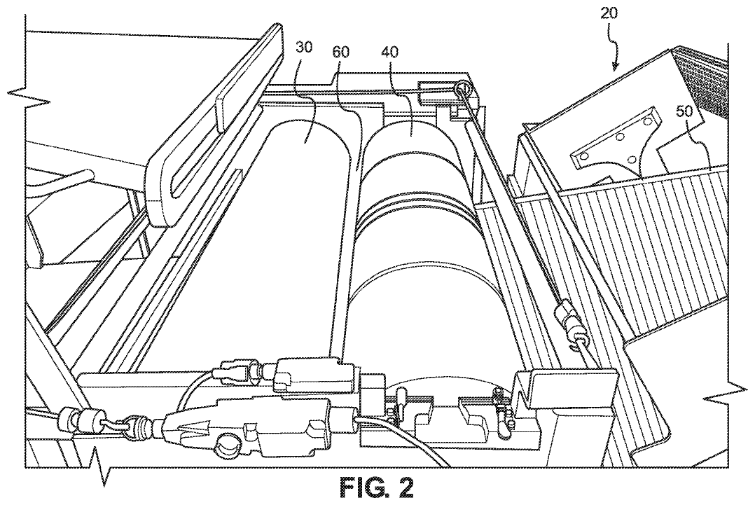

More specifically and with reference to FIG. 2, the rear roller 30 and the front roller 40 are mounted parallel to each other to define a pinch point gap 60. The hopper assembly 20 (FIG. 1) is mounted above the rear roller 30 and the front roller 40 so as to support dough (not separately shown), such as masa above the pinch point gap 60. As the rear roller 30 and the front roller 40 are driven in counter-rotating directions, the masa is pulled into the pinch point gap 60. A thin layer of dough is discharged from the pinch point gap and adhered to an outer surface of the front roller 40.

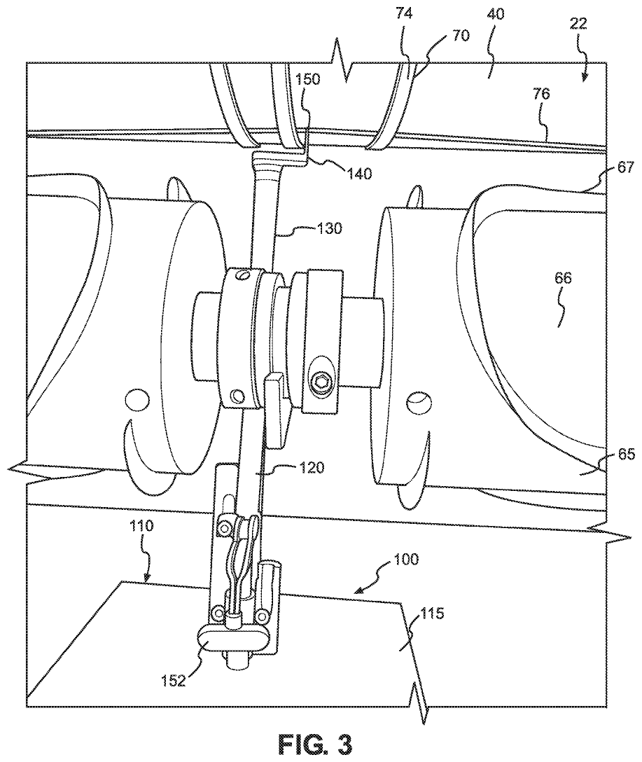

With reference to FIG. 3, the roller assembly 22 can also include a cutting roller 65. As the sheet of dough moves counterclockwise along with the front roller 40, the dough is passed between the cutting roller 65 and the outer surface of the front roller 40. The cutting roller 65 is designed for taco manufacturing, and thus includes round-shaped recesses 66 and edges 67 for cutting the round shaped dough pieces 45. While round shapes are shown, the cutting roller 65 could cut the dough sheet into any desired shape. The front roller 40 also includes a plurality of grooves 70, in which bands 74 are disposed. The grooves 70 have an inner surface that has a smaller diameter than the inner surface of the bands 74. The bands 74 are sufficiently large that the bands 74 can be pulled approximately parallel or slightly projecting from the outer surface of the front roller 40.

A stripper wire otherwise known as a traveling wire 76 is secured to the roller assembly 22 at locations adjacent to both ends of the front roller 40 and downstream from the cutting roller 65. More specifically, the traveling wire 76 is mounted at the right end of the front roller 40 adjacent to the right-most point of contact and secured at the left end of the front roller 40 adjacent to the left-most point of contact. The traveling wire is threaded under the bands 74.

With continued reference to FIG. 3, during operation, the rotation of the front roller 40, and the resulting friction between the traveling wire 76 and the outer surface of the front roller 40 and the bands 74 (which rotate with the front roller 40) causes the traveling wire 76 to be pulled in the upward direction. As such, the traveling wire tends to follow an arched shape around the front roller 40.

The front roller 40 will typically have plurality of bands 74 preferably made of plastic and spaced about the circumference of the front roller 40. These bands 74 ride in groves in the front roller 40 and hold the traveling wire 76 close to the surface of the front roller 40. As such, the traveling wire 76 can strip off cut pieces of dough from the outer surface of the front roller 40 yet allow remaining pieces of dough, referred to as “rework”, to remain in contact with the bands 34 and be fed back into the hopper assembly 20 so as to become reworked with the dough 32 above the pinch point gap 60.

The bands 74 also provide a surface for returning ribbons of unused masa to the hopper assembly 20. The traveling wire 76 is shown strung across the face of the front roller 40. This traveling wire 76 is threaded across the face of the front roller 40 underneath each of the bands 74. This provides a flush contact between the traveling wire 76 and the surface of the front roller 40. The traveling wire 76 may be held under tension and also moved along the surface of the front roller 40. Details of a device for providing tension to the traveling wire can be found in U.S. Pat. No. 6,268,005, incorporated herein by reference.

The traveling wire 76 is typically commercial piano wire. A typical tension on the traveling wire during operation is approximately 100 to 125 pounds. Contact with hardened masa, particularly during start-up, can subject the traveling wire 76 to higher tension for short time periods. During operation, the traveling wire 76 is also subject to friction from the moving face of the front roller 40.

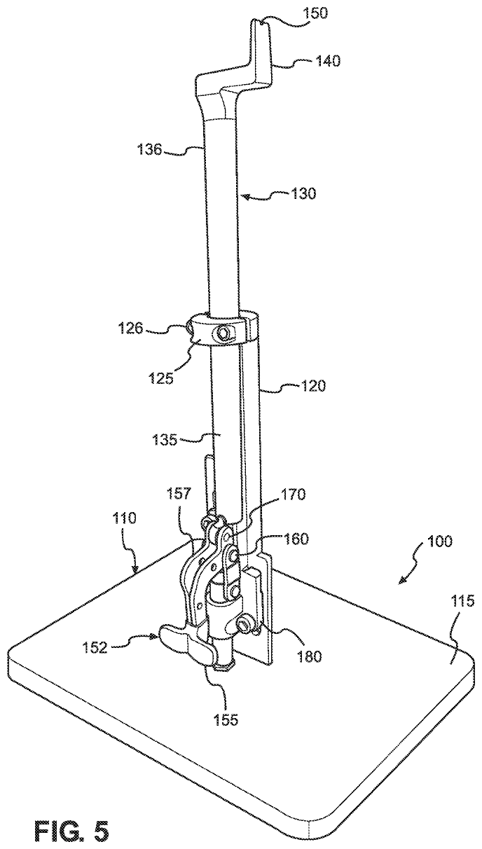

As shown in FIG. 3-5, a bracket 100 for holding the traveling wire 76 includes a base plate 110 which is of generally a square shape 115 and is preferably made of steel. A support track 120 is mounted on the base plate 110 and extends vertically. As best seen in FIG. 5, a retainer 125 is attached to the support track 120 with fasteners 126. A rod 130 is adjustably mounted in the support track 120. The rod 130 includes a mounting portion 135 secured in the support track 120 by the retainer 125. The rod 130 also includes a guide portion 136 fixed to the mounting portion 135 and extending above the retainer 125. The guide portion 136 includes a tab 140 with a notch 150 configured to support the traveling wire 76.

A lever assembly 152 is mounted on the base plate 110 and is connected to the rod 130. The lever includes a handle 155, preferably made of a soft plastic mounted on a metal lever arm 157. The metal lever arm 157 is pivotably mounted between a link 160 and the mounting portion 135 at a pivot 170. Link 160 is connected to the support track 120 by supporting member 180. The supporting member 180 is shown attached to the mounting portion 135 but could also be attached to the base plate 110.

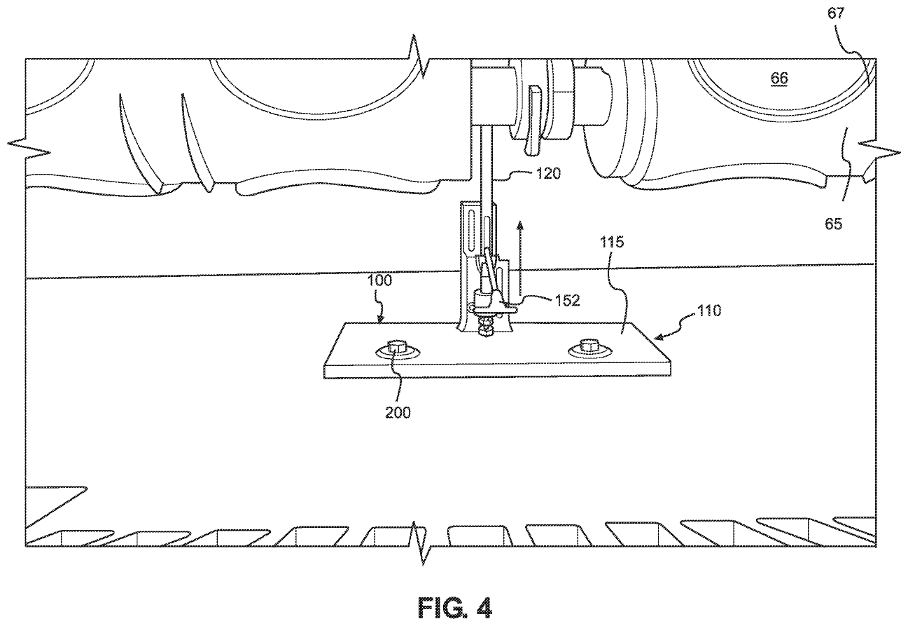

In operation the bracket 100 retains a traveling wire 76 in the dough sheeting machine 10. As best seen in FIG. 4, the bracket 100 is installed by positioning the base plate 110 under the front roller 40 of the dough sheeting machine 10 and securing the base plate 110 with fasteners 200. The tab 140 of the bracket 100 is positioned near the traveling wire 76 and then the height of the tab 140 is adjusted by moving the lever assembly 152. Moving the lever assembly 152 causes the bracket to move from a lowered stowed configuration wherein the traveling wire 76 is disengaged from the notch 150 to a raised deployed position wherein the traveling wire 76 is placed within the notch 150. The notch 150 supports the traveling wire 76. The link 160 and pivot 170 allow the lever assembly 152 to smoothly engage the traveling wire while the notch 150 keeps the traveling wire 76 from moving excessively when the front roller 40 is turning but allows the traveling wire 76 to move longitudinally.

As can be seen from the discussion above the embodiments include a bracket that retains the traveling wire in proper position, while preventing excessive wear on the sheeter rolls, and intermittent jumping of the traveling wire.

1. A dough sheeting machine comprising:
a support housing;
a roller supported in the housing;
a traveling wire assembly, including a traveling wire amount disposed adjacent a face of the roller; and
a traveling wire bracket including a base plate, a support track mounted on the base plate, and a rod adjustably mounted in the support track, the rod including a mounting portion secured in the track and a guide portion fixed to the mounting portion and including a tab with a notch configured to retain the traveling wire in proper position, while preventing excessive wear on the roller, and intermittent jumping of the traveling wire.

2. The dough sheeting machine of claim 1 further comprising a retainer attached to the support track with fasteners.

3. The dough sheeting machine of claim 1 further comprising a lever mounted on the base plate and connected to the rod, the lever configured to move the rod along the support track from a lowered stowed configuration disengaging the traveling wire from the notch to a raised deployed position engaging the traveling wire with the notch.

4. The dough sheeting machine of claim 3, wherein the lever includes a handle made of a soft plastic mounted on a metal lever arm pivotably attached to a link and the mounting portion.

5. The dough sheeting machine of claim 4, wherein the link is connected to the support track by a supporting member attached to the mounting portion.

6. The dough sheeting machine of claim 4, wherein the link is connected to the support track by a supporting member attached to the base plate.

7. The dough sheeting machine of claim 1 further comprising a rear roller having a first outer surface and supported by the support housing to rotate about a first axis.

8. The dough sheeting machine of claim 7 wherein the roller is a front roller having a second outer surface and is supported by the support housing to rotate about a second axis spaced from the first axis such that juxtaposed portions of the first and second outer surfaces define a pinch point gap.

9. The dough sheeting machine of claim 8 further comprising a hopper assembly located above the pinch point gap.

10. A method of retaining a traveling wire in a dough sheeting machine including a support housing, a roller supported in the housing, a traveling wire assembly, having a traveling wire disposed adjacent a first end of the roller, said method comprising:
positioning, near the traveling wire, a traveling wire bracket including a base plate, a support track mounted on the base plate, and a rod, the rod having a mounting portion secured in the track and a guide portion fixed to the mounting portion and having a tab with a notch; and
supporting the traveling wire in the notch.

11. The method of claim 10 further comprising retaining the traveling wire in proper position, while preventing excessive wear on the roller, and intermittent jumping of the traveling wire.

12. The method of claim 10 further comprising adjusting a height of the bracket by moving from a lowered stowed configuration to a raised deployed position.

13. The method of claim 12 further comprising engaging the traveling wire with the notch wherein the notch supports the wire.

14. The method of claim 13 further comprising attaching a retainer to the support track with fasteners.

15. The method of claim 14 further comprising moving the rod along the support track by a lever mounted on the base plate and connected to the rod.
